(19) United States
(12) Patent Application Publication
(10) Pub. No.: US 2025/0147154 A1
(43) Pub. Date: May 8, 2025

(54) DISPLACEMENT SENSORS CONSTRUCTED USING LOW COST ToF SENSORS AND OPTICAL FIBERS WITH LARGE ELONGATION CAPABILITIES

(71) Applicant: NEC Laboratories America, Inc., Princeton, NJ (US)

(72) Inventors: Yaowen LI, Princeton, NJ (US); Hao WANG, West Windsor, NJ (US); Yuheng CHEN, South Brunswick, NJ (US); Ting Wang, West Windsor, NJ (US)

(73) Assignee: NEC Laboratories America, Inc., Princeton, NJ (US)

(21) Appl. No.: 18/935,515

(22) Filed: Nov. 2, 2024

Related U.S. Application Data
(60) Provisional application No. 63/595,990, filed on Nov. 3, 2023.

(51) Int. Cl. G01S 7/481; G01S 7/4865; G01S 17/894

(52) U.S. Cl. CPC G01S 7/4818; G01S 7/4816; G01S 7/4865; G01S 17/894

(57) ABSTRACT

Disclosed are displacement sensors constructed from optical fibers having a long elongation with low-cost ToF sensors that advantageously do not suffer the infirmities of the art. The ToF sensor and the optical fiber ends that launch and receive light are packaged such that no ambient light affects measurements, and the structure is protected from contamination which eliminates optical degradation. With multi-point measurement capabilities and the low-cost features of ToF sensors, many displacement sensors can be arranged in a mesh to map out displacements over a large area and over all directions for civil and/or geotechnical structures. Wireless or other communications mechanisms may be employed in conjunction with our novel sensors to send real time measurement data to a central office for real time monitoring and analysis.

### CROSS-REFERENCE TO RELATED APPLICATIONS

This application claims the benefit of U.S. Provisional Patent Application Ser. No. 63/595,990 filed Nov. 3, 2023, the entire contents of which is incorporated by reference as if set forth at length herein.

### FIELD OF THE INVENTION

This application relates generally to optical systems and structures. More particularly it pertains to displacement sensors constructed using low-cost time-of-flight sensors and optical fibers with large elongation capabilities.

### BACKGROUND OF THE INVENTION

Low-cost sensors used to measure the displacements from millimeters up to 10 s of centimeters or more have found application in many areas, especially in civil and geotechnical engineering. In optical methods, interferometric techniques are usually employed for small displacement measurements much smaller than 1 mm. Other optical techniques require one to transfer the displacement to a measurable optical parameter using some complex mechanical mechanisms. Furthermore, with these methods, the optical systems usually are not low-cost ones. For example, techniques using fiber Bragg gratings (FBGs) and Brillouin scattering of light require interrogating systems costing thousands or tens of thousands of dollars.

A Time-of-Flight (ToF) sensor (as used herein, a direct ToF sensor) is an optical system for measuring a distance between a light emitting point and object struck by light and subsequently reflected. Recently, the cost, size and measurement accuracy of ToF sensors have been improved tremendously. Such sensors now cost only tens of dollars while exhibiting measurement accuracies in millimeters and physical size(s) smaller than a USB memory stick.

Flexible optical fibers, such as polymer optical fibers, have been developed for short distance communications—among other applications. For these plastic optical fibers, their yield strains usually are in the 1% to 5% range with break strains in the 10% to 30% range and are commercially available.

More recently, silicon optical fibers have been developed which have been demonstrated to exhibit 100% —or more—strain without breaking.

For displacement measurements, setting up a target and using a ToF sensor to measure the distance change through the air are oftentimes proposed as workable measurement arrangements. Unfortunately however, in field use changes in visibility, ambient light intensity, target surface reflection, light source and receiver window contamination, and other factors negatively influence/degrade measurement robustness and accuracy. Using the optical fibers with long elongation capabilities and low-cost ToF sensors to build the displacement sensors can solve and/or improve these issues.

### SUMMARY OF THE INVENTION

The above problems are solved and an advance in the art is made according to aspects of the present disclosure directed the use of optical fibers having a long elongation with low-cost ToF sensors to construct displacement sensors which advantageously do not suffer the infirmities of the art.

In sharp contrast to the prior art, our inventive displacement sensors include low-cost ToF sensors and optical fibers having a long elongation. The ToF sensor and the optical fiber ends that launch and receive light are packaged such that no ambient light affects measurements, and structure is protected from contamination which produces optical degradation. With multi-point measurement capabilities and the low-cost features of ToF sensors, many displacement sensors according to aspects of the present disclosure can be arranged in a mesh to map out displacements over a large area and over all directions for civil and/or geotechnical structures.

As we shall show and describe in further detail, our inventive displacement sensors employ the low-cost ToF sensors and optical fibers having long elongation. Our inventive displacement sensors may be arranged in a mesh, permitting mapping over a large area and multiple directions. Finally, our inventive sensors may employ wireless or other communications mechanisms to send real time measurement data to a central office for real time monitoring and analysis.

### BRIEF DESCRIPTION OF THE DRAWING

FIG. 1 is a schematic diagrams showing an illustrative single displacement sensor in a transmission configuration according to aspects of the present disclosure.

FIG. 2 is a schematic diagrams showing an illustrative measurement accuracy and resolution improvement in the transmission configuration according to aspects of the present disclosure.

FIG. 3(A) and FIG. 3(B) are plots of length vs time for measurements for the 2 m and 4 m plastic fibers according to aspects of the present disclosure.

FIG. 3(C) shows 2 m and 4 m fiber measurement results in tabular form according to aspects of the present disclosure.

FIG. 4 is a plot of length vs time for measurements for the 4 m fibers according to aspects of the present disclosure.

FIG. 5 is a schematic diagrams showing an illustrative fiber length change test according to aspects of the present disclosure.

FIG. 6 is a plot of length vs time for measurement results from pulling part of the 4 m fibers according to aspects of the present disclosure.

FIG. 7 is a plot of length vs time for measurements for the 21 m flexible fibers according to aspects of the present disclosure.

FIG. 8 is a schematic diagrams showing an illustrative single displacement sensor in reflection configuration according to aspects of the present disclosure.

FIG. 9 is a schematic diagrams showing an illustrative measurement accuracy and resolution improvement in the reflection configuration according to aspects of the present disclosure.

FIG. 10 is a schematic diagrams showing an illustrative multi target tests in air using time-of-flight (ToF) sensor according to aspects of the present disclosure.

FIG. 11(A) is a plot of length vs time for measurements for multi target test results in air according to aspects of the present disclosure.

FIG. 11(B) shows multi test results in air in tabular form according to aspects of the present disclosure.

FIG. 12 is a schematic diagram showing an illustrative one of the multi point sensor configurations according to aspects of the present disclosure.

FIG. 13 is a schematic diagram showing another illustrative one of the multi point sensor configurations according to aspects of the present disclosure.

FIG. 14 is a schematic diagram showing still another illustrative one of the multi point sensor configurations according to aspects of the present disclosure.

FIG. 15(A) and FIG. 15(B) show plots of length vs time for measurements of the lengths of 2×2 coupler output legs according to aspects of the present disclosure.

FIG. 16 is a schematic diagram showing multi-point displacement sensors in a mesh configuration according to aspects of the present disclosure.

FIG. 17 shows a schematic flow/block diagram of illustrative features/relationship/sequence of operating elements of systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As will be understood by those skilled in the art, a direct ToF sensor comprises an emitter that emits an optical pulse, a single-photon avalanche diode (SPAD), a high-resolution timing circuit and any relevant electronics. The SPAD comprises a p-n junction reverse-biased above its breakdown voltage (Geiger-mode).

As a result, a single photon hitting the junction generates a detectable current flow and outputs as a digital pulse. These pulses can be timed by the high-resolution timing circuit. This time information then can be converted to distance information when the speed of light in the medium is known. Multiple pulse frames can be captured, and a histogram of the time measurements can be recorded to improve the distance measurement resolution. Distances of multi targets separated over a certain distance can also be measured by the ToF sensor. Furthermore, ToF sensors constructed with the SPAD arrays and corresponding electronics can map the 3D contour of an object by imaging the object onto the array. Each SPAD pixel acts like an individual ToF sensor to measure the distance of the point on the object and imaged onto the SPAD pixel.

We disclose and describe displacement sensors based on low-cost ToF sensors and optical fiber with long elongation capabilities in both transmission and reflection configurations, and some variations in each configuration. We address these configurations and their variations.

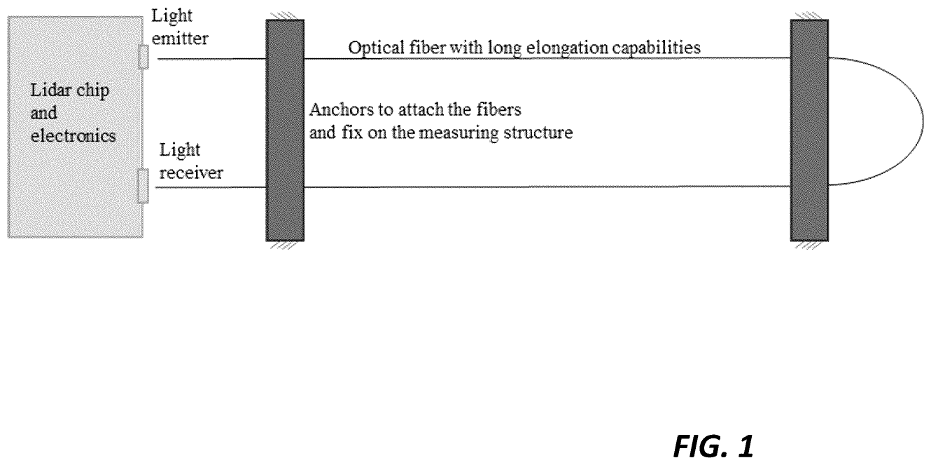

FIG. 1 is a schematic diagrams showing an illustrative single displacement sensor in a transmission configuration according to aspects of the present disclosure.

With reference to that figure, it may be observed that a flexible optical fiber is looped back, and one of its ends is aligned to an emitter while the other end is aligned to a receiver. Two locations on the fiber—separated by a certain distance—are bonded onto two anchors. When deployed as a sensor, these two anchors are fixed on two locations of a structure. The relative displacement between these two locations can be measured by the ToF sensor measuring the fiber length change.

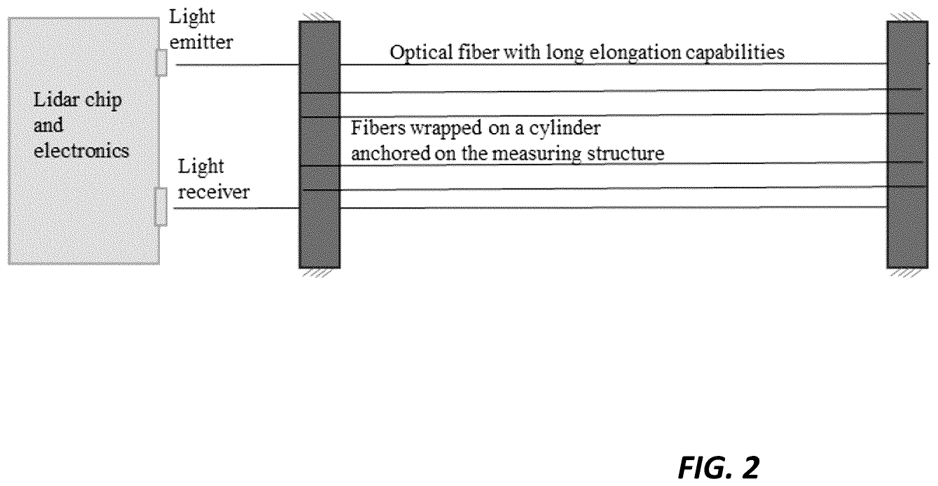

To amplify the magnitude of the length change for a small displacement, and thus improve the measurement accuracy and resolution, a multi-pass configuration variation shown in FIG. 2 can be employed. To measure the displacement in both directions along the fiber, pre-stretching can be done during the anchor installations.

FIG. 2 is a schematic diagrams showing an illustrative measurement accuracy and resolution improvement in the transmission configuration according to aspects of the present disclosure.

To demonstrate this configuration, a VL53L4CX STM32 light, 3D Time-of-Flight (Tof) sensor with its evaluation board is used. This ToF sensor can measure a maximum distance of 6 m in air, and thus around 8 m fiber length for the configuration in FIG. 1. Two pieces of a plastic fiber (Mitsubishi ESKA®, 250 μm Fiber) with lengths of 2 m and 4 m are used for the tests to obtain the average refractive index value of the fiber core. Since the firmware and software supplied by the manufacturer calculate the distance in air and a single trip, the calculation for the physical fiber length in this configuration is

$$Fiber length = \frac{ToF measured value \times 2}{core refractive index} \qquad ( 1 )$$

The averaged refractive index for this fiber is 1.48980. The TOF measurement variation against the averaged value is +/−2 mm. This translates to around +/−3 mm actual fiber length measurement variation

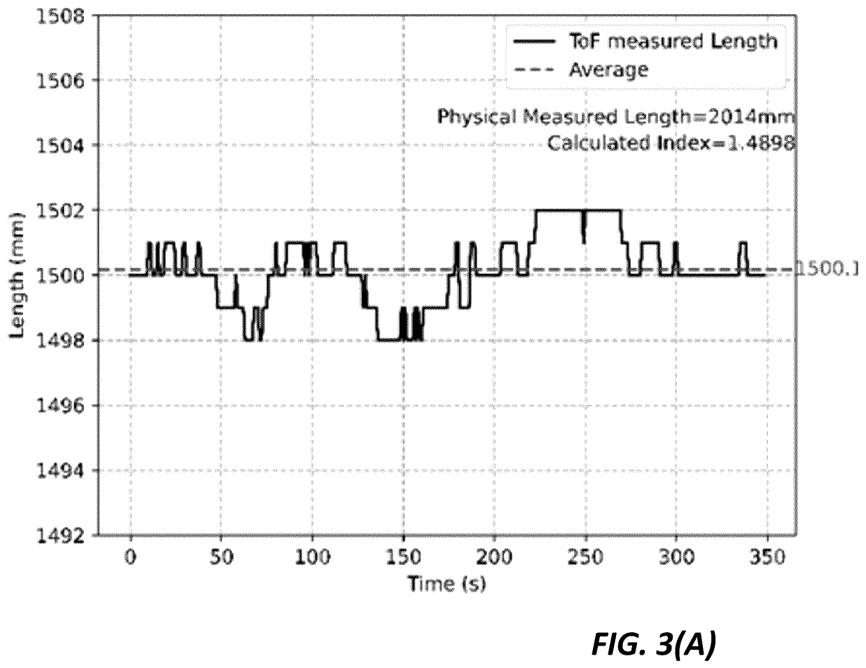

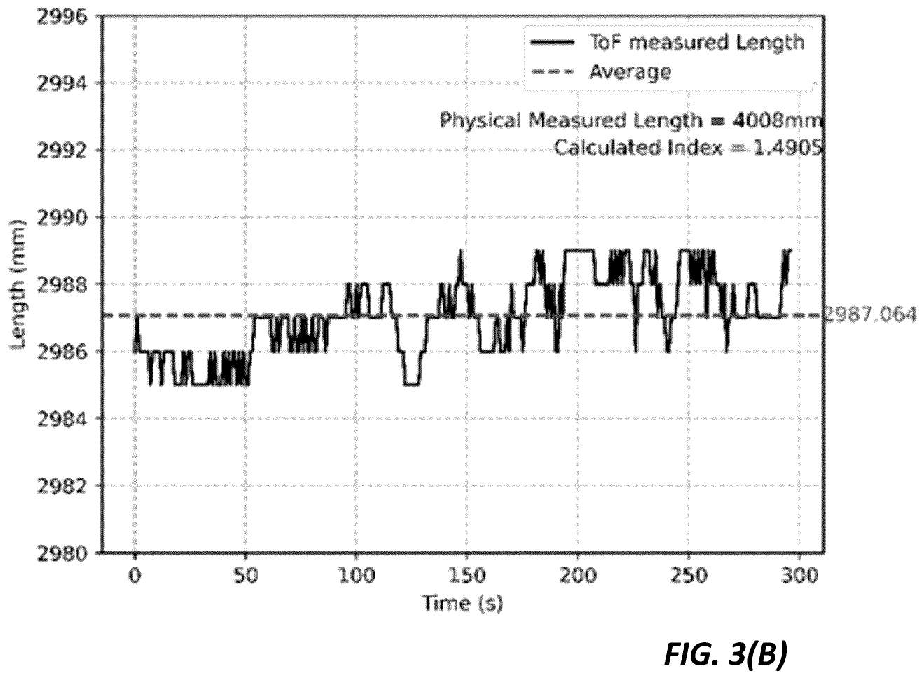

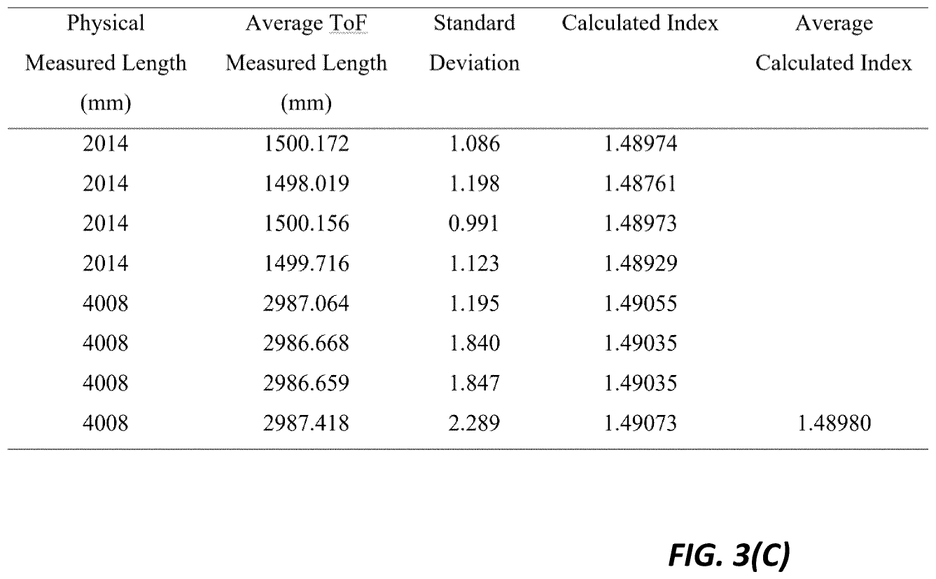

FIG. 3(A) and FIG. 3(B) are plots of length vs time for measurements for the 2 m and 4 m plastic fibers according to aspects of the present disclosure.

FIG. 3(C) shows 2 m and 4 m fiber measurement results in tabular form according to aspects of the present disclosure.

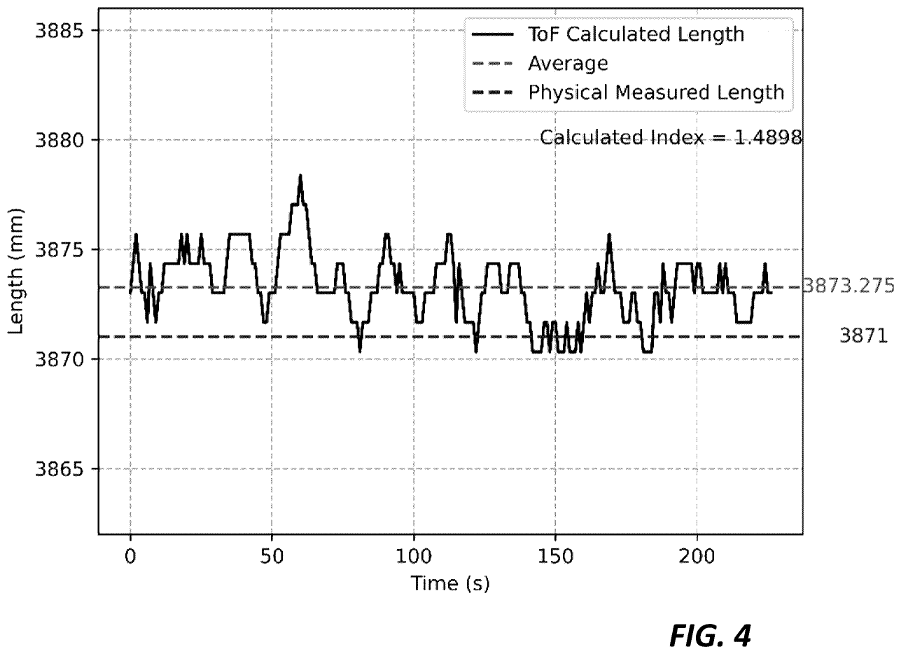

Another 4 m long fiber is then measured and calculated using the obtained index value. The measured fiber length averaged in around 250 s period of time is 2.2 mm longer than the actual fiber length. The result is shown in FIG. 4 which is a plot of length vs time for measurements for the 4 m fibers according to aspects of the present disclosure.

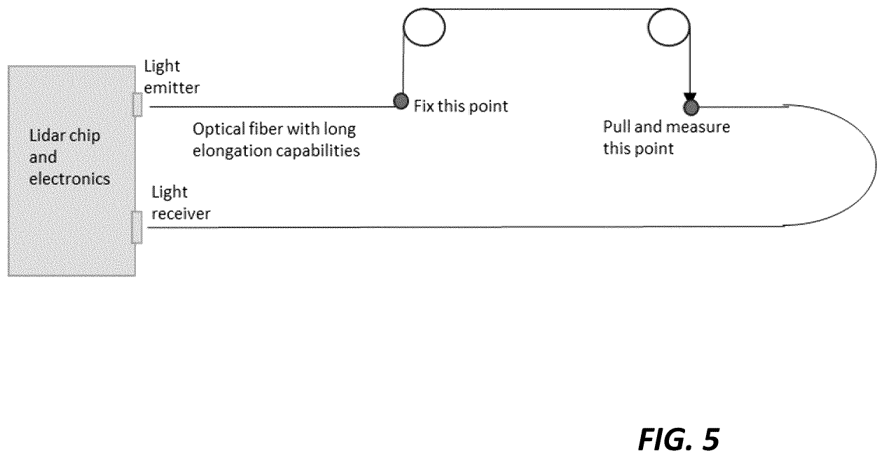

This ˜4 m fiber is also set up to do the stretching displacement test as schematically shown in FIG. 5 which is a schematic diagrams showing an illustrative fiber length change test according to aspects of the present disclosure.

Part of the fiber (1.65 m) is set up on a pulley system with one side fixed and the other side pulled by a weight. Measuring the displacement at the weight applying point gives the fiber length change. A 57 g initial weight is applied and the ToF sensor measures the entire fiber length to be 3879.33 mm (calculated using the averaged index value of 1.4898). A 114 g weight is then added on and the measurements are taken and the entire fiber length changes to 3895.49 mm. The weight applying point displacement is measured to be 15 mm. So, the difference between the ToF result and actual displacement is 1.16 mm.

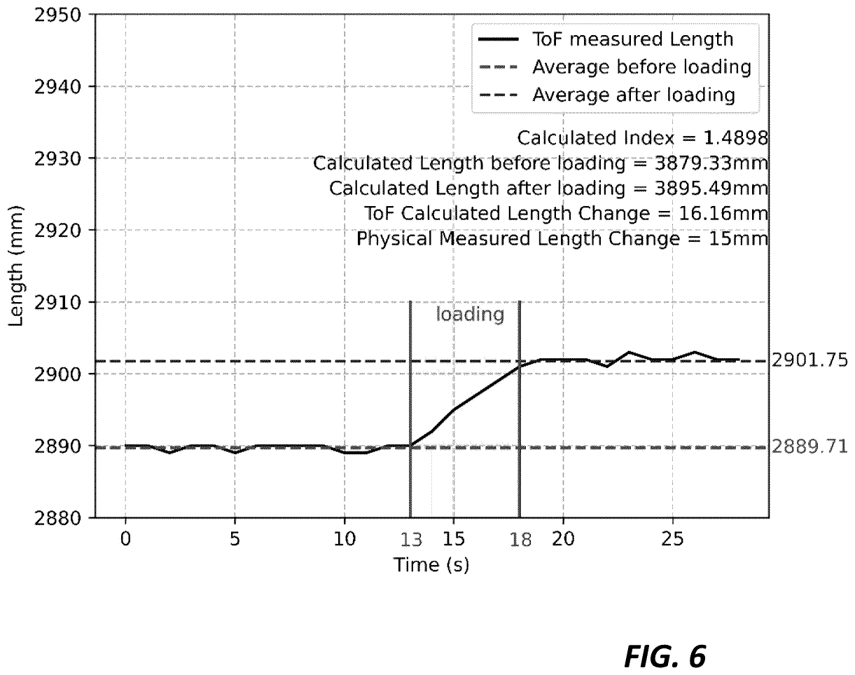

FIG. 6 is a plot of length vs time for measurement results from pulling part of the 4 m fibers according to aspects of the present disclosure.

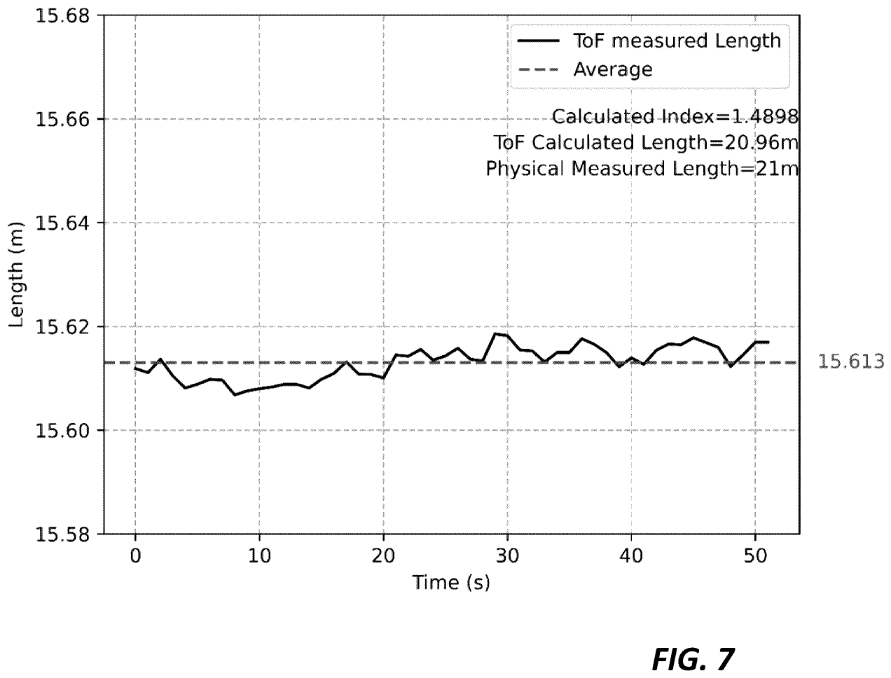

Commercially available ToF sensors also can measure the distances in 10 s of meters or up to 100 m. AFBR-S50MV68B—Light, 3D Time-of-Flight (ToF) Sensor by Broadcom Limited is one of them and has a capability to measure up to 100 m distance. This sensor also images the points on an object to an SPAD array and each SPAD pixel acts as a ToF sensor to measure the distance of the corresponding point on the object. A ˜21 m fiber same as that used in the above tests is tested using this ToF sensor. The test configuration is same as that in FIG. 1. The results are shown in FIG. 7 which is a plot of length vs time for measurements for the 21 m flexible fibers according to aspects of the present disclosure. Using the previously obtained index value to calculate the fiber length results in 20.96 m of ToF measured fiber length. This is close to the roughly measured actual fiber length of ˜21 m.

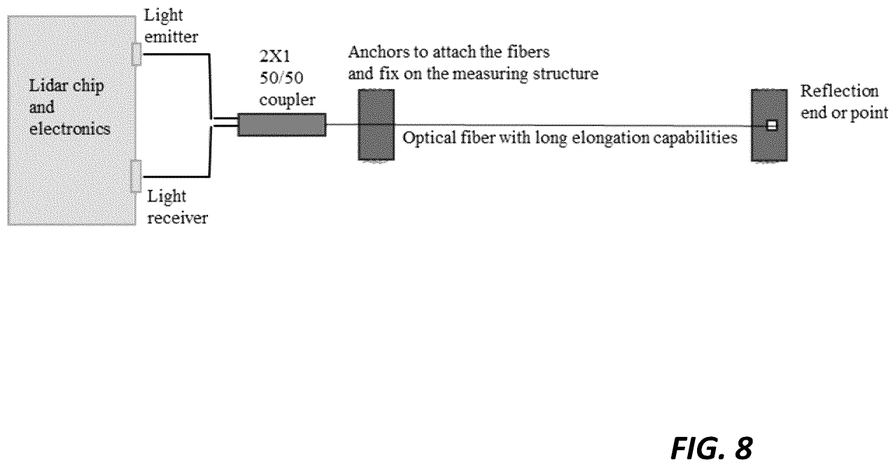

FIG. 8 is a schematic diagrams showing an illustrative single displacement sensor in reflection configuration according to aspects of the present disclosure.

A 50/50 2×1 optical fiber coupler with equal lengths of the light launching and receiving legs is used. The flexible optical fiber is connected to the other leg. Reflection from the end can be just from the broken or cleaved end. Same as that in FIG. 1, two separated points of the fiber are boned onto the two anchors. In this configuration, the calculation from the measurement for the fiber length is

$$Fiber length = \frac{ToF measured value}{core refractive index} \qquad ( 2 )$$

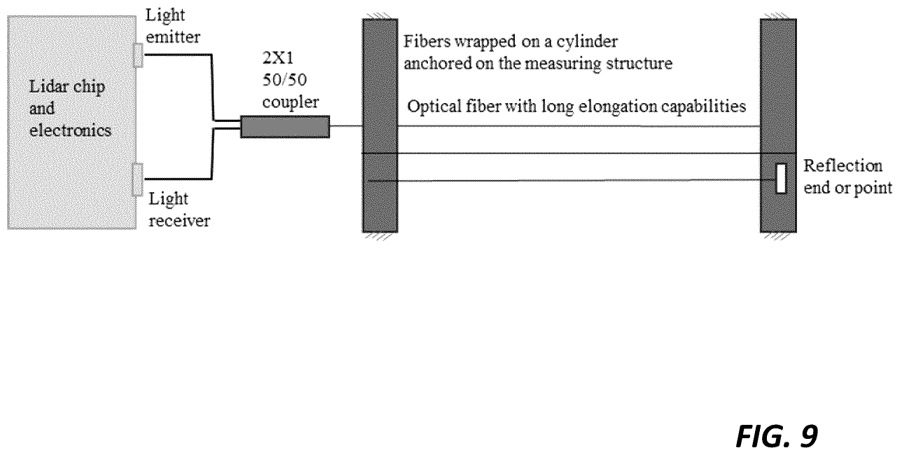

FIG. 9 is a schematic diagrams showing an illustrative measurement accuracy and resolution improvement in the reflection configuration according to aspects of the present disclosure.

Like that in FIG. 2, to improve the small displacement measurement accuracy and resolution, the configuration variation in FIG. 9 can be employed. Also, same as that in the transmission configuration, to measure the displacements in both directions along the fiber, pre-stretching can be done during the anchor installations.

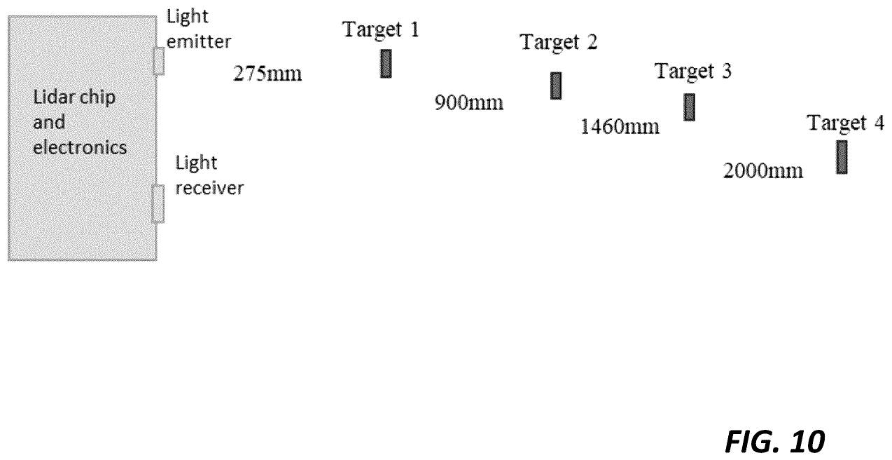

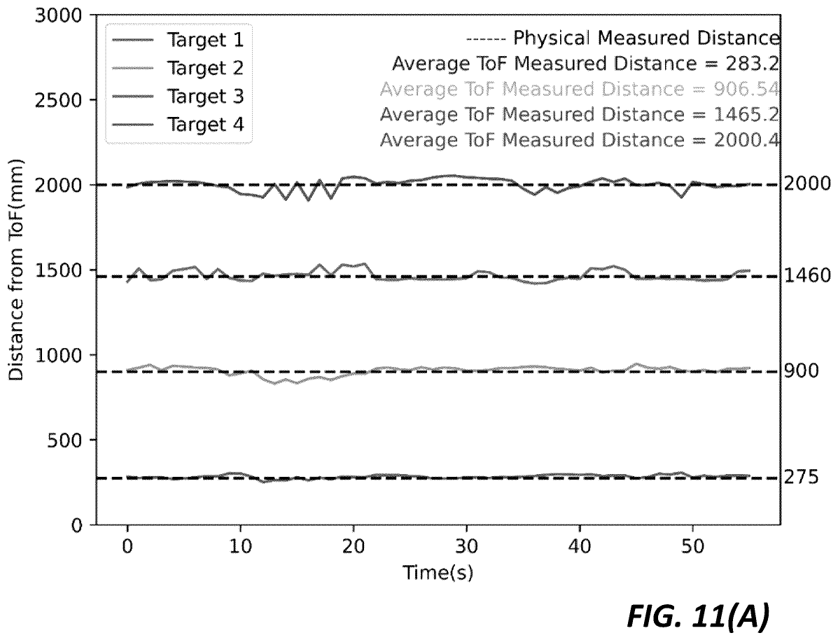

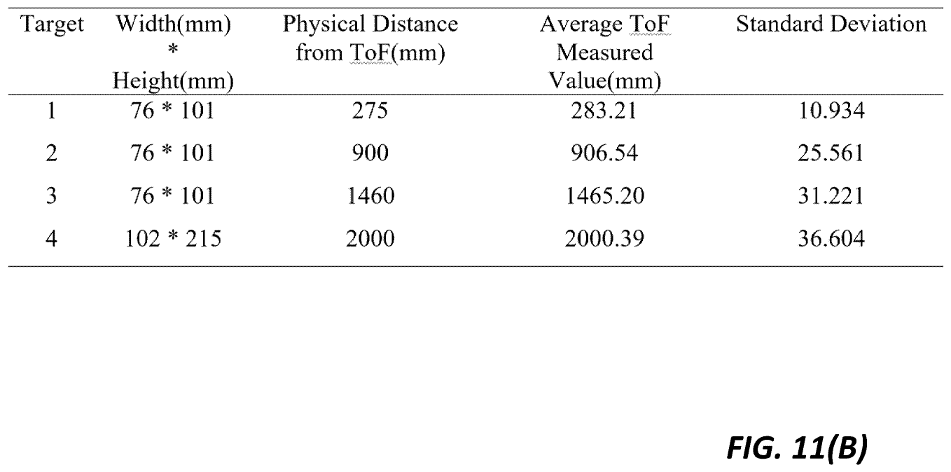

ToF sensors are also capable of measuring multi-targets. FIG. 10 is a schematic diagrams showing an illustrative multi target tests in air using time-of-flight (ToF) sensor according to aspects of the present disclosure. The ToF sensor is a VL53L4CX STM32 light, 3D Time-of-Flight (ToF) sensor and its evaluation board. FIG. 11(A) and FIG. 11(B) show the results. The targets are thing white boards and set up on big paper clips. The target sizes are shown in FIG. 11(B).

FIG. 11(A) is a plot of length vs time for measurements for multi target test results in air according to aspects of the present disclosure.

FIG. 11(B) shows multi test results in air in tabular form according to aspects of the present disclosure.

It can be found that in air, the measurement variations are much bigger than those shown in FIGS. 3 and 4 of the displacement sensor configurations. The differences between the measured average distances and actual distances are also bigger. The main reasons are believed to be the weak received signals and influences from the surroundings, such as the table surface.

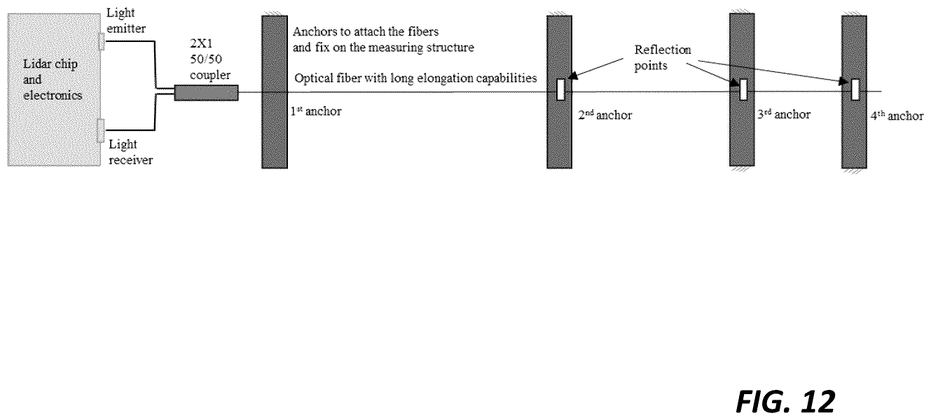

Based on this multi-target measurement capability of the ToF sensor, displacement sensors to measure multi displacements can be constructed in a reflection configuration. FIG. 12 is a schematic diagram showing an illustrative one of the multi point sensor configurations according to aspects of the present disclosure and shows one scenario.

In the configuration shown, multi-reflection points are created in the flexible fiber and the corresponding anchors are assembled between the adjacent reflection points. The fiber length at each reflection point is measured. The displacements between two adjacent anchors can be calculated from these fiber length measurements.

Assuming before the first anchor point, there is no fiber length change. The displacement value between the first two anchors is the measured fiber length change at the second reflection point before and after the displacement occurs. The displacement value between the second and third anchors is the measured fiber length change at the third reflection point before and after the displacement occurs and subtraction from the displacement between the first two anchors. The calculation continues until all the displacements between the two adjacent anchors are obtained. Of course, the accuracy and resolution improvement shown in FIG. 8 can be applied to here too.

The multiple reflective spots in the flexible fibers may be created by making the localized fiber core index changes in the existing fibers, for example, in the plastic fiber case, using laser beams to illuminate the fiber core or to write FBG-like structures in the fiber core, or by adding the reflective materials during the fiber fabrication.

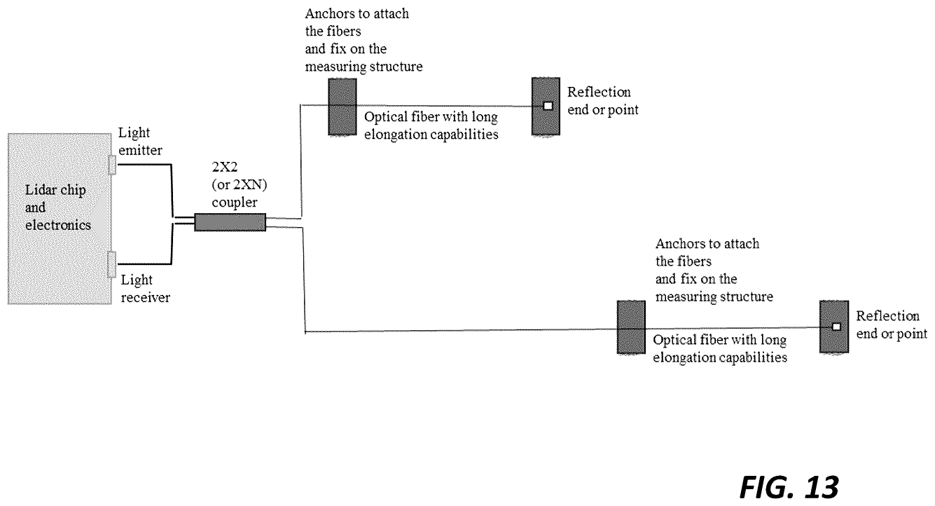

Another scenario to configure the multi displacement measurement is shown in FIG. 13 which is a schematic diagram showing another illustrative one of the multi point sensor configurations according to aspects of the present disclosure.

In this configuration, a 2×N coupler is used and every output branch of this coupler is constructed as a displacement sensor. The original length differences among the branches depend on the ToF algorithms and resolution and a minimum value can be determined before the sensor assembly.

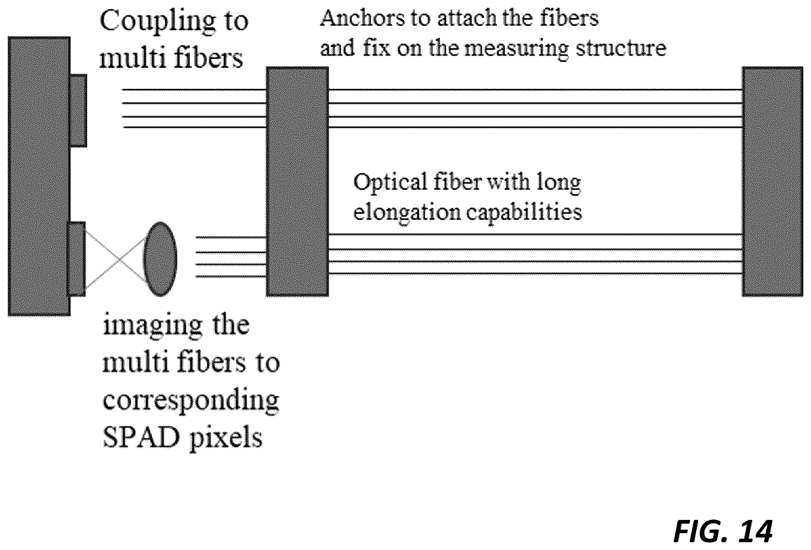

A third scenario is to use the SPAD array based ToF sensors. The configuration is shown in FIG. 14 which is a schematic diagram showing still another illustrative one of the multi point sensor configurations according to aspects of the present disclosure, and it's in the transmission configuration. The emitter couples the light to a bundle of fibers and each individual fiber can have its own independent anchor arrangement. In the receiving side, the bundle of fibers is imaged to the SPAD array, and each fiber corresponds to an assigned SPAD pixel. In this way, the length of each fiber will be measured.

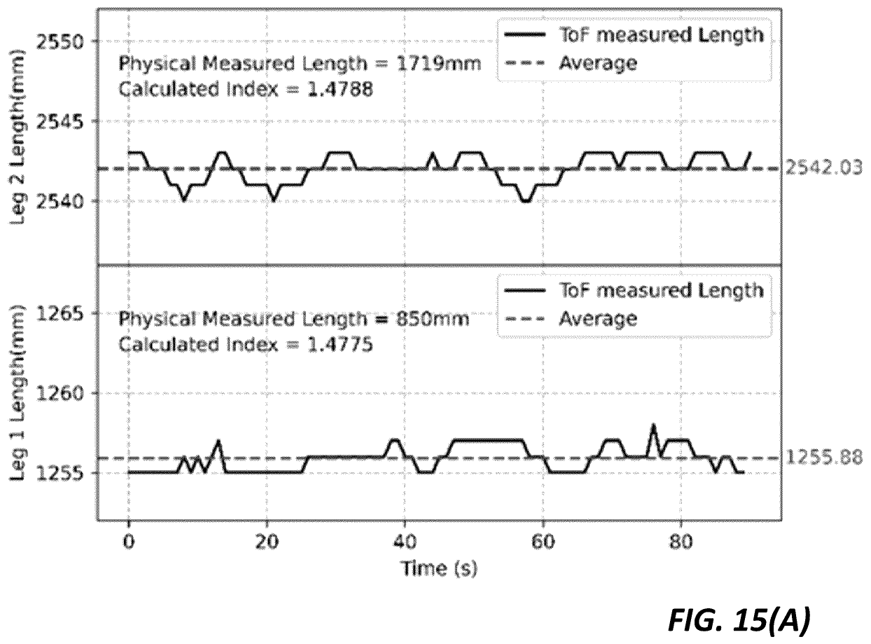

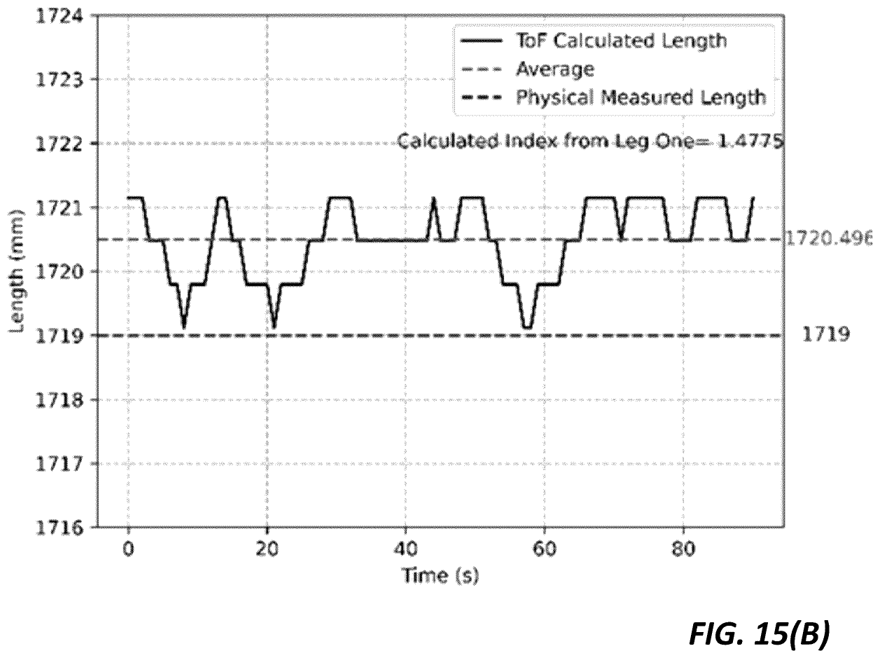

The configuration in FIG. 13 with a regular telecom multimode 2×2 coupler is used to demonstrate the length measurements of the two output coupler legs. The results are shown in FIG. 15(A) and FIG. 15(B). The light launching and receiving leg lengths are equal. One output leg, plus the launching leg, is 850 mm long and the other 1719 mm long. The ToF sensor measures the lengths of 1255.88 mm and 2542.03 mm. The fiber core index is calculated from the 850 mm leg length to be 1.4775. Using this index value, the other leg length calculated by Equation 2 is 1720.50 mm. The difference between this measured value and the physically measured value, 1719 mm, is 1.50 mm.

FIG. 15(A) and FIG. 15(B) show plots of length vs time for measurements of the lengths of 2×2 coupler output legs according to aspects of the present disclosure.

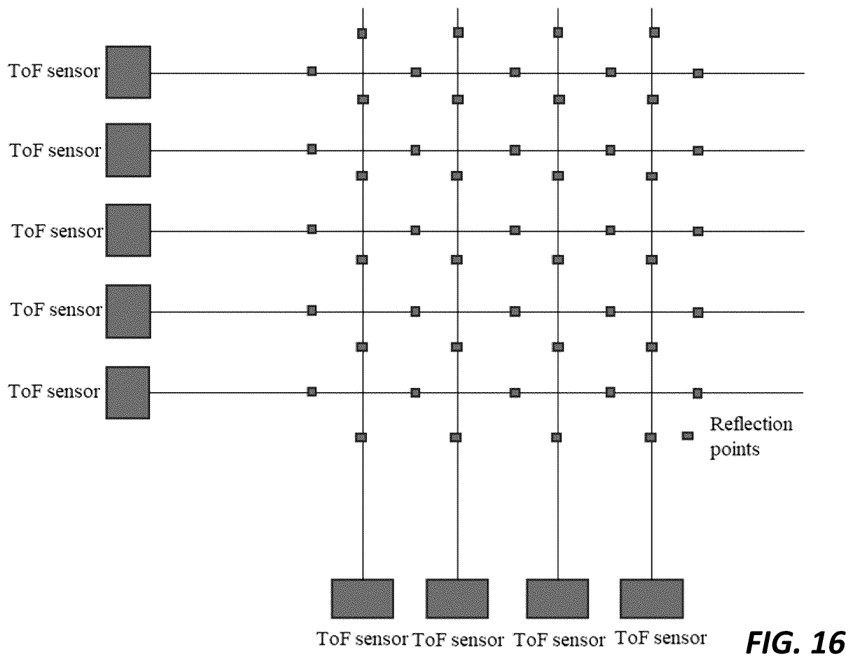

FIG. 16 is a schematic diagram showing multi-point displacement sensors in a mesh configuration according to aspects of the present disclosure.

In real applications, such as geophysical engineering, displacement measurements in a big area and two directions are required. Because of the low-cost ToF sensors, it's possible to deploy the muti point displacement sensors in a mesh arrangement to meet these requirements. FIG. 16 shows this arrangement with the multi point displacement sensors in the reflection configuration. Similarly, the configuration in FIG. 14 can be arranged in a similar mesh form for the displacement measurements in this scenario.

Because of extremely low power consumption for the sensor and its electronics, in the field applications without nearby power accesses, a solar panel may be used to power up many sensors. Wireless and other communications may be used to transmit the measurement data to a nearby office for real-time monitoring. Due to the low-cost merit of the sensor, redundant design, namely installation of more than enough ToF sensors, can be applied to further increase the overall robustness for the critical applications.

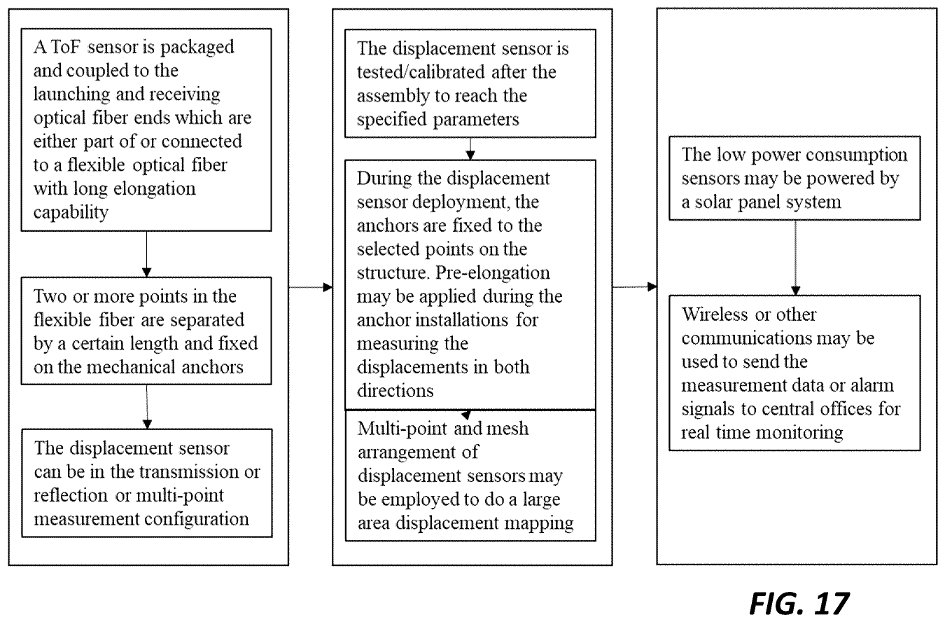

FIG. 17 shows a schematic flow/block diagram of illustrative features/relationship/sequence of operating elements of systems and methods according to aspects of the present disclosure.

While we have presented our inventive concepts and description using specific examples, our invention is not so limited. Accordingly, the scope of our invention should be considered in view of the following claims.

1. A displacement sensor comprising:
LiDAR circuitry including a light emitter and a light receiver;
an optical fiber capable of elongation having one end optically connected to the light emitter of the LiDAR circuitry and another end optically connected to the light receiver of the LiDAR circuitry;
a pair of anchors displaced apart from one another and affixed to the optical fiber;
wherein the LiDAR circuitry is configured to operate and determine a relative displacement between the two anchors.

2. The displacement sensor of claim 1 wherein the optical fiber is arranged in a single loop configuration such that the optical fiber is affixed to each anchor at two points.

3. The displacement sensor of claim 1 wherein the optical fiber is arranged in a multi-pass configuration such that the optical fiber is affixed to each anchor at more than two points effectively forming multiple loops of fiber between the light emitter and the light receiver.

4. A displacement sensor comprising:
LiDAR circuitry including a light emitter and a light receiver;
an optical fiber capable of elongation having one end optically connected to both the light emitter of the LiDAR circuitry and the light receiver of the LiDAR circuitry through the effect of an optical coupler;
a plurality of anchors displaced apart from one another and affixed to the optical fiber;
wherein the LiDAR circuitry is configured to operate and determine a relative displacement between the plurality of anchors.

5. A displacement sensor comprising:
LiDAR circuitry including a light emitter and a light receiver;
a plurality of optical fibers capable of elongation each having one end optically connected to both the light emitter of the LiDAR circuitry and the light receiver of the LiDAR circuitry through the effect of an optical coupler;
a plurality of anchors displaced apart from one another and respectively affixed to the optical fibers such that each of the plurality of optical fibers has affixed thereto at least two of the plurality of anchors that are not affixed to any of the other optical fibers;
wherein the LiDAR circuitry is configured to operate and determine a relative displacement between the plurality of anchors.
